(19) United States
(12) Patent Application Publication
(10) Pub. No.: US 2025/0392686 A1
(43) Pub. Date: Dec. 25, 2025

(54) PROJECTION DEVICE

(71) Applicant: Coretronic Corporation, Hsin-Chu (TW)

(72) Inventors: Chao-Lin Hsu, Hsin-Chu (TW); Chun-Ju Wang, Hsin-Chu (TW); Bo-Heng Zhou, Hsin-Chu (TW)

(73) Assignee: Coretronic Corporation, Hsin-Chu (TW)

(21) Appl. No.: 19/241,341

(22) Filed: Jun. 17, 2025

(30) Foreign Application Priority Data
Jun. 19, 2024 (CN) 202410792862.6

(51) Int. Cl. H04N 9/31

(52) U.S. Cl. CPC H04N 9/317; H04N 9/3105

(57) ABSTRACT

A projection device including a light source module, a light modulation module, an actuation module and a projection lens. The light source module is configured to provide first color light and second color light with different wavelength distributions, and the light modulation module is configured to convert the first color light and the second color light into first image light and second image light respectively. The actuation module includes an actuator, and the actuator has a light incident surface adapted to be deflected. When the actuation module performs a lateral color compensation operation, the light incident surface of the actuator when receiving the first image light has a first deflection angle relative to the light incident surface of the actuator when receiving the second image light, and the first image light and the second image light are projected to a preset range through the projection lens to generate an image.

### CROSS-REFERENCE TO RELATED APPLICATION

This application claims the priority benefit of China application serial no. 202410792862.6, filed on Jun. 19, 2024. The entirety of the above-mentioned patent application is hereby incorporated by reference herein and made a part of this specification.

### BACKGROUND

### Technical Field

The disclosure relates to a projection device.

### Description of Related Art

Light source technology used in projection devices has evolved from ultra-high-pressure mercury lamps to red, green, and blue light-emitting diodes, and then evolved to color projectors with laser diodes in line with market requirements on projection brightness, color saturation, and service life, etc. Along with technology innovation, a number of optical components in projection devices has also increased, and a design of optical path has become more and more complex. However, light beams of different colors have different refraction angles with respect to a same medium (i.e., the cause of chromatic dispersion), such that when various colors of light passes through multiple optical components and complex optical paths from the light source to a projection surface, the various colors of light that is originally imaged within a same preset range may produce color halo, resulting in chromatic aberration, especially lateral color.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

An embodiment of the disclosure provides a projection device including a light source module, a light modulation module, an actuation module and a projection lens. The light source module is configured to provide first color light and second color light, and the first color light and the second color light have different wavelength distributions. The light modulation module is disposed on a transmission path of the first color light and the second color light, and is configured to convert the first color light and the second color light into first image light and second image light respectively. The actuation module is disposed on a transmission path of the first image light and the second image light, and is configured to receive the first image light and the second image light. The actuation module includes at least one actuator, and each actuator has a light incident surface adapted to be deflected relative to a reference surface. The projection lens is disposed on the transmission path of the first image light and the second image light, and is configured to receive the first image light and the second image light. When the actuation module performs a lateral color compensation operation, the light incident surface of the actuator when receiving the first image light has a first deflection angle relative to the light incident surface of the actuator when receiving the second image light, and the first image light and the second image light are projected to a preset range through the projection lens to generate an image.

Accordingly, the projection device of the disclosure uses an actuation module to refract light beams of different colors, which may cause different shifts to different color pixels in each pixel. Therefore, even if different colors of light are shifted due to different refraction angles in the projection device, the shift amount caused by the actuation module may compensate for the shift of different colors of light, so that the image beams of different colors may be substantially overlapped within the preset range, i.e., image beams of different colors are formed at expected positions of each pixel in the image frame. Therefore, the issue of chromatic dispersion or lateral color of image may be mitigated, which effectively improves the imaging quality of the image and increase the user's viewing experience. On the other hand, compared to redesigning or remolding a projection lens with a complex structure to solve such issues, the deflection method of the disclosure utilizing the actuation module is relatively simple, and the original projection lens structure may also be used, which substantially increases flexibility in component selection for the projection device.

To make the aforementioned more comprehensible, several embodiments accompanied with drawings are described in detail as follows.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic structural diagram of a projection device according to an embodiment of the disclosure.

FIG. 2A to FIG. 2E are schematic side views of a working principle of an actuation module in FIG. 1.

FIG. 3A to FIG. 3F are schematic three-dimensional views of a working principle of the actuation module in FIG. 1.

FIG. 4A and FIG. 4B are schematic diagrams of mitigating shift of different color pixels in the projection device according to an embodiment of the disclosure.

FIG. 5A is a diagram showing a relationship between deflection angles in each period when an actuator performs a pixel shift operation according to an embodiment of the disclosure.

FIG. 5B is a diagram showing a relationship between the deflection angles in each period when the actuator performs a lateral color compensation operation according to an embodiment of the disclosure.

FIG. 5C is a diagram showing a relationship between the deflection angles in each period when the actuator performs a pixel shift operation and a lateral color compensation operation at the same time according to an embodiment of the disclosure.

FIG. 6 is a schematic structural diagram of a projection device according to an embodiment of the disclosure.

FIG. 7A to FIG. 7D are diagrams illustrating a relationship between deflection angles in each period when an actuation module of the projection device of the embodiment of FIG. 6 performs operations.

FIG. 8 is a schematic structural diagram of a projection device according to an embodiment of the disclosure.

FIG. 9 is a diagram showing a relationship between deflection angles in each period when an actuation module of the projection device of the embodiment of FIG. 8 performs operations.

FIG. 10 is a schematic structural diagram of a projection device according to an embodiment of the disclosure.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

The disclosure provides a projection device that may mitigate a color halo problem of various colors of light in the projection device, thereby improving image quality of the projection device.

Additional aspects and advantages of the disclosure will be set forth in the description of the techniques disclosed in the disclosure.

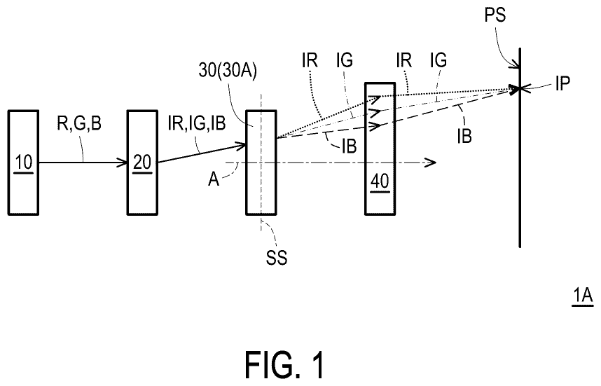

FIG. 1 is a schematic structural diagram of a projection device according to an embodiment of the disclosure. Referring to FIG. 1, a projection device 1A includes a light source module 10, a light modulation module 20, an actuation module 30 and a projection lens 40. The light source module 10 may be configured to provide a first color light R and a second color light G. In an embodiment, the light source module 10 may further provide a third color light B. In the following description, the light source module 10 providing three colors of light is taken as an example for explanation, where a wavelength distribution of the first color light R may have greater intensity at 620-750 nanometers (nm) (i.e. a red light wavelength), a wavelength distribution of the second color light G may have greater intensity at 495-570 nm (i.e., a green light wavelength), and a wavelength distribution of the third color light B may have greater intensity at 450-495 nm (i.e., a blue light wavelength), i.e., the wavelength distribution of the first color light R, the wavelength distribution of the second color light G, and the wavelength distribution of the third color light B may be different from each other, but the disclosure is not limited thereto. In some embodiments, the first color light R, the second color light G, and the third color light B may have narrower wavelength distributions.

The light source module 10 may include, for example, a laser diode or a solid-state laser, and in some embodiments, it may also be other types of light sources, such as light-emitting diodes, and the light source type of the light source module 10 is not limited by the disclosure. The light source module 10 may further include a light splitting element (such as a color splitter, a color wheel, a polarizing beam splitter, etc.), a wavelength conversion element (such as a phosphor wheel), a lens group (such as a plurality of condenser lenses or a lens array), and a light homogenizing element (such as an integrating rod, a diffuser or a fly-eye lens) and other optical components (which are all not shown), so as to guide the first color light R, the second color light G and the third color light B out of the light source module 10, but the disclosure is not limited thereto.

The light modulation module 20 is configured on a transmission path of the first color light R, the second color light G and the third color light B from the light source module 10, so as to respectively convert the first color light R, the second color light G and the third color light B into, for example, a first image light IR of a red color, a second image light IG of a green color, and a third image light IB of a blue color. In the embodiment, the light modulation module 20 includes a light modulation element, such as a digital micro mirror device (DMD), a liquid crystal on silicon panel (LCOS panel) or other suitable spatial light modulators (SLM), etc. In some embodiments, the light modulation module 20 may also be a transmissive liquid crystal panel, but the disclosure is not limited thereto. The projection lens 40 is disposed on a transmission path of the first image light IR, the second image light IG, and the third image light IB, and is used to receive the first image light IR, the second image light IG, and the third image light IB, and configured to project the first image light IR, the second image light IG and the third image light IB out of the projection device 1A, for example, onto a projection surface PS (such as a projection screen) to form an image IP. In the embodiment, the light modulation module 20 may include a single light modulation element, i.e., the projection device 1A may be a single digital light processing (DLP) projector system.

The actuation module 30 is disposed on the transmission path of the first image light IR, the second image light IG, and the third image light IB, and is used to receive the first image light IR, the second image light IG, and the third image light IB. The actuation module 30 is located between the light modulation module 20 and the projection lens 40. The actuation module 30 may include at least one actuator, such as one or a plurality of actuators 30A, and one actuator is illustrated in FIG. 1 for exemplary explanation. In addition, each of the at least actuators 30A has a light incident surface IF (not shown in FIG. 1) that may be deflected relative to a reference surface SS. When the actuator 30A is in an initial placement position before swinging, the light incident surface IF of the actuator 30A is parallel to the reference surface SS. The reference surface SS may be substantially perpendicular to an optical axis A of the projection lens 40, i.e., the reference surface SS is parallel to a plane perpendicular to the optical axis A. However, the disclosure is not limited thereto.

The actuator 30A includes a flat transparent medium that may swing in a position, for example, an expanded pixel resolution (XPR) technology may be used to control the actuator 30A with current or voltage to drive a connected optical refractive plate (such as high transmittance glass) makes it swing back and forth, and a swing angle is related to an input current or a voltage strength.

In the embodiment, the actuator 30A swings when receiving the first image light IR, the second image light IG, and the third image light IB. By swinging the light incident surface IP of the actuator 30A relative to the reference surface SS, the image light passing through the actuator 30A may produce lateral displacement, so as to adjust lateral color caused by the image light of different colors. In the following, in the specification, “the operation of controlling the deflection of the actuator to adjust the lateral color of image light of different colors” may be referred to as “lateral color compensation operation”.

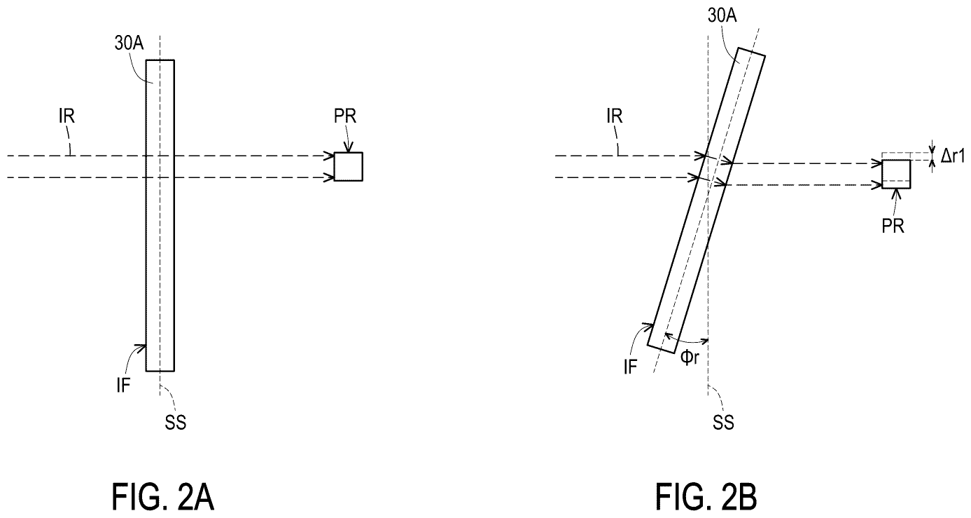

FIG. 2A to FIG. 2E are schematic side views of a working principle of the actuation module in FIG. 1. An embodiment in which the actuation module 30 includes a single actuator 30A will be described below. Referring to FIG. 2C first, when the actuator 30A is in the initial placement position and has not started to deflect, the light incident surface IF is parallel to the reference surface SS. The second image light IG may be substantially vertically incident on the light incident surface IF of the actuator 30A, thereby forming a second color pixel PG. Similarly, referring to FIG. 2A, when the actuator 30A is in the initial placement position and has not started to deflect, the light incident surface IF is parallel to the reference surface SS. The first image light IR may be substantially vertically incident on the light incident surface IF of the actuator 30A, thereby forming a first color pixel PR. However, different colors of light cause different refraction angles due to differences in wavelength, so that each color pixel in a same pixel, such as the first color pixel PR and the second color pixel PG, may be projected at different positions, so that the actuation module 30 may be used to perform the lateral color compensation operation.

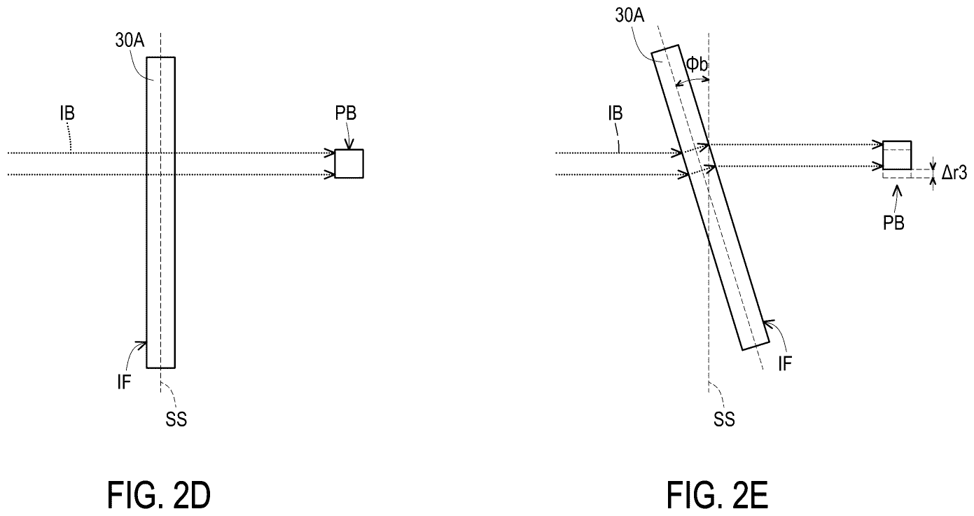

Referring to FIG. 2B, when the actuator 30A performs the lateral color compensation operation, the light incident surface IF may have a first deflection angle ϕr compared to the reference surface SS, and the first deflection angle ϕr is greater than 0 degree. At this time, a position of the first color pixel PR generated after the first image light IR passes through the actuator 30A may have a first shift amount Δr1. Therefore, the shift of the first color pixel PR may be compensated through the first shift amount Δr1, so that the first color pixel PR is projected into a preset range (for example, a preset range DE in FIG. 4A and FIG. 4B, which will be described later).

When the actuation module 30 performs the lateral color compensation operation, the light incident surface IF (as shown in FIG. 2B) of the actuator 30A when receiving the first image light IR has the above-mentioned first deflection angle ϕr relative to the light incident surface IF (as shown in FIG. 2C) of the actuator 30A when receiving the second image light IG. To be specific, in the embodiment, when the actuation module 30 performs the lateral color compensation operation, the light incident surface IF of the actuator 30A when receiving the second image light IG is not deflected relative to the reference surface SS, so that the incident light surface when receiving the second image light IG may be considered to be the same as the reference surface SS. The deflection angle may also be understood as, when the actuator 30A is not configured in the path of the second image light IG, the first deflection angle ϕr is defined by the reference surface SS and the light incident surface IF of the actuator 30A when receiving the first image light IR. At this time, the position of the second color pixel PG generated by the second image light IG on the projection surface PS can may be used as a reference to define the imaging position of the second color pixel PG as a position of the preset range DE. Certainly, the disclosure is not limited thereto. In other embodiments, the position of the second color pixel PG generated by the second image light IG on the projection surface PS is not used as a reference. Namely, when the actuation module 30 performs the lateral color compensation operation, the light incident surface IF when the second image light IG is incident to the actuator 30A is not parallel to the reference surface SS, but has a deflection angle with the reference surface SS, so as to compensate for the lateral color of the second image light IG. At this time, the above-mentioned the first deflection angle ϕr is still presented between the light incident surface IF of the actuator 30A when receiving the second image light IG and the light incident surface IF of the actuator 30A when receiving the first image light IR.

Similarly, referring to FIG. 2D, when the actuator 30A is in the initial placement position and has not started to deflect, the light incident surface IF is parallel to the reference surface SS. The third image light IB may be substantially vertically incident on the light incident surface IF of the actuator 30A, thereby forming a third color pixel PB. Referring to FIG. 2E again, when the actuator 30A performs the lateral color compensation operation, the light incident surface IF may have a second deflection angle ϕb compared to the reference surface SS, and the second deflection angle ϕb is greater than 0 degree. At this time, a position of the third color pixel PB generated after the third image light IB passes through the actuator 30A changes, i.e., a second shift amount Δr3 is generated. Therefore, the shift of the third color pixel PB may be compensated through the second shift amount Δr3, and the third color pixel PB is projected to the preset range DE in FIG. 4A and FIG. 4B. It should be noted that in FIG. 2B and FIG. 2E, the first deflection angle ϕr and the second deflection angle ϕb with a same magnitude but different directions are taken as an example for descriptions, but the disclosure is not limited thereto. In some embodiments, the first deflection angle ϕr and the second deflection angle ϕb may have different magnitudes or may have a same direction. Regarding the magnitudes or directions of the first deflection angle ϕr and the second deflection angle ϕb, a level of chromatic dispersion of the first image light IR, the second image light IG and the third image light IB in the projection device 1A may first be learned through experiments or data simulations, and then an operating current or voltage of the actuation module 30 is then controlled through, for example, a solid-state processor (CPU, not shown), so as to adjust the magnitudes of the first deflection angle ϕr and the second deflection angle ϕb, thereby controlling magnitudes of the first shift amount Δr1 and the second shift amount Δr3. Therefore, the actuator 30A may compensate the lateral color of the first color pixel PR, the second color pixel PG and the third color pixel PB, so that the first color pixel PR, the second color pixel PG and the third color pixel PB in the same pixel may be projected within the preset range DE, thereby mitigating the color halo phenomenon of the generated image IP.

In the side views of FIG. 2A to FIG. 2E, the actuator 30A is in a swing state of a single rotation axis, but the disclosure is not limited thereto. In some embodiments, the first deflection angle ϕr and the second deflection angle ϕb of the actuator 30A may be multi-dimensional deflection angles, i.e., the first deflection angle ϕr and the second deflection angle ϕb may swing not only along a rotation axis of a one-dimensional direction, but also along a rotation axis of a two-dimensional direction.

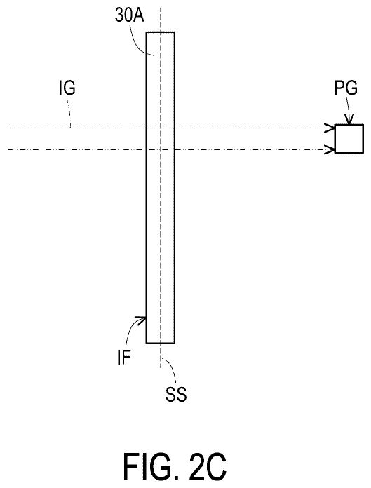

For example, FIG. 3A to FIG. 3F are schematic three-dimensional views of a working principle of the actuation module in FIG. 1. Taking FIG. 3A and FIG. 3B as an example, FIG. 3A shows that when the actuation module is not deflected, the first image light IR passes through the actuator 30A and generates a plurality of first color pixels PR (three first color pixels PR are taken as an example in FIG. 3A). In FIG. 3B, the light incident surface of the actuator 30A is deflected by an angle θx′ while taking a direction Y as a rotation axis. At this time, the plurality of first color pixels PR generated after the first image light IR passes through the actuator 30A may generate a displacement Δx′. Namely, through the deflection of the actuator 30A, the plurality of first color pixels PR generate the displacement Δx′ from the original position (as shown in FIG. 3A) and move to a dotted line position (as shown in FIG. 3B). Similarly, taking FIG. 3C and FIG. 3D as an example, FIG. 3C shows that when the actuation module is not deflected, the first image light IR passes through the actuator 30A and generates a plurality of first color pixels PR. In FIG. 3D, the light incident surface of the actuator 30A is deflected by an angle θy′ while taking a direction X as a rotation axis, and at this time, the plurality of first color pixels PR generated after the first image light IR passes through the actuator 30A may generate a displacement Δy′. Therefore, in some embodiments, an amount of the actuators 30A included in the actuation module 30 may be two. The two actuators 30A are respectively one-dimensional deflection actuators capable of deflecting with respect to a single rotation axis, thereby respectively controlling the displacement Δx′ and the displacement Δy′ of the first color pixel PR (or the aforementioned second color pixel PG and third color pixel PB) to perform the lateral color compensation operation.

Referring to FIG. 3E and FIG. 3F again, FIG. 3E shows that when the actuation module is not deflected, the first image light IR passes through the actuator 30A and generates a plurality of first color pixels PR. In some embodiments (such as FIG. 3F), the actuator 30A may be able to rotate in two directions, for example, the actuator 30A may take the direction X and the direction Y as the rotation axes to generate a first deflection angle ϕr (or the aforementioned second deflection angle ϕb) in a multi-dimensional direction, i.e., the actuator 30A may be a two-dimensional deflection actuator. In FIG. 3F, the actuator 30A may simultaneously control a vector sum of the displacement Δx′ and the displacement Δy′ of the first color pixel PR (or the aforementioned second color pixel PG and third color pixel PB) to generate the aforementioned first shift amount Δr1 (or the aforementioned second shift amount Δr3), so as to perform the lateral color compensation operation. Namely, the disclosure does not limit the type and amount of the actuators 30A in the actuation module 30.

FIG. 4A and FIG. 4B are schematic diagrams of mitigating shift of different color pixels in the projection device according to an embodiment of the disclosure. Referring to FIG. 4A first, when the actuator 30A is not swinging, the first color pixel PR, the second color pixel PG and the third color pixel PB in the same pixel cannot completely overlap in the preset range DE due to chromatic dispersion (i.e., the pixel position where each color is expected to be imaged). In this way, a pixel 100 generated by superposition of the first color pixel PR, the second color pixel PG and the third color pixel PB may produce color halo or lateral color at periphery of the preset range DE or in the area where the colors partially overlap.

Referring to FIG. 4B, the lateral color compensation operation is performed by the aforesaid actuator 30A, taking the position of the second color pixel PG as a reference, the position of the second color pixel PG is designed to be the same as the preset range DE, and the first color pixel PR and the third color pixel PB are respectively made to generate the first shift amount Δr1 and the second shift amount Δr3, whereby the first color pixel PR, the second color pixel PG and the third color pixel PB may all be projected within the preset range DE, and a pixel 200 generated by superposition of the first color pixel PR, the second color pixel PG and the third color pixel PB is concentrated in the preset range DE. Namely, in each frame of the image IP, the first image light IR, the second image light IG, and the third image light IB completely overlap on at least one pixel of the image IP. In this way, the lateral color of the image IP may be mitigated and the quality of the image IP is improved.

On the other hand, in addition to providing the lateral color compensation operation, the XPR technology may also be used to make the actuation module 30 to swing back and forth at an angle within a human visual persistence time, thereby the first image light IR, the second image light IG and the third image light IB may have displacement. This operation allows the pixel composed of the first color pixel PR, the second color pixel PG and the third color pixel PB to be displaced at high speed (for example, displaced by length of a half pixel) without being noticed by the human eye, thereby improving a resolution (for example, to increase the resolution from 2K to 4K, or increase the resolution from 2K to 8K) of the image IP. In the following description, “using the XPR technology to make the first color pixel PR, the second color pixel PG and the third color pixel PB moving at a high speed without being detected by the human eye, thereby improving the resolution of the image IP” may be referred to as “pixel shift operation”, and “the displacement produced by the pixel (or color pixel) when performing the pixel shift operation” is referred to as “pixel displacement”.

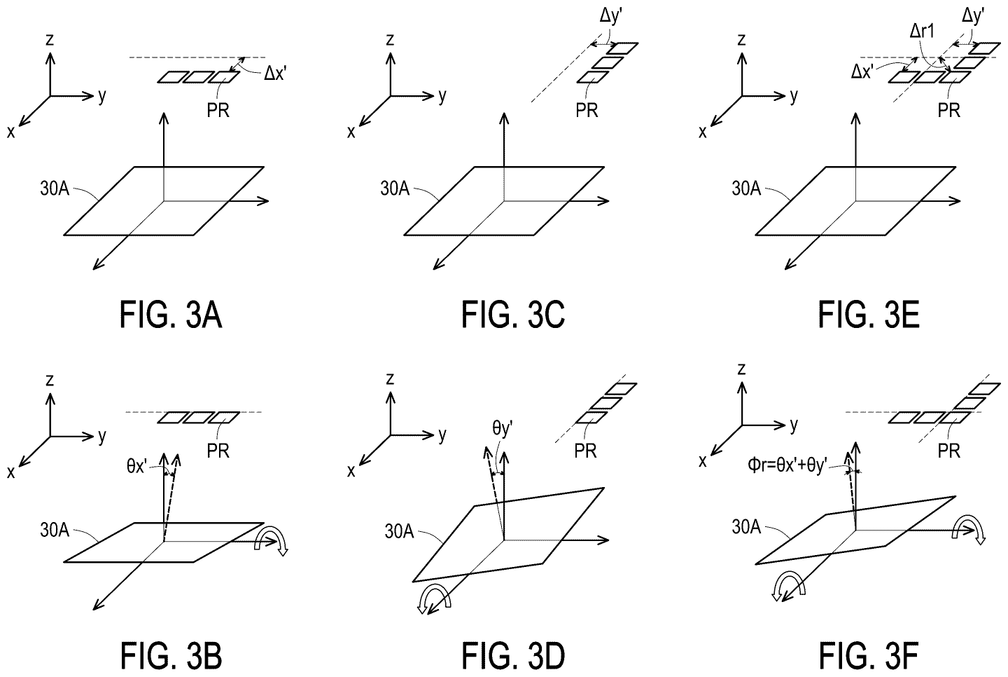

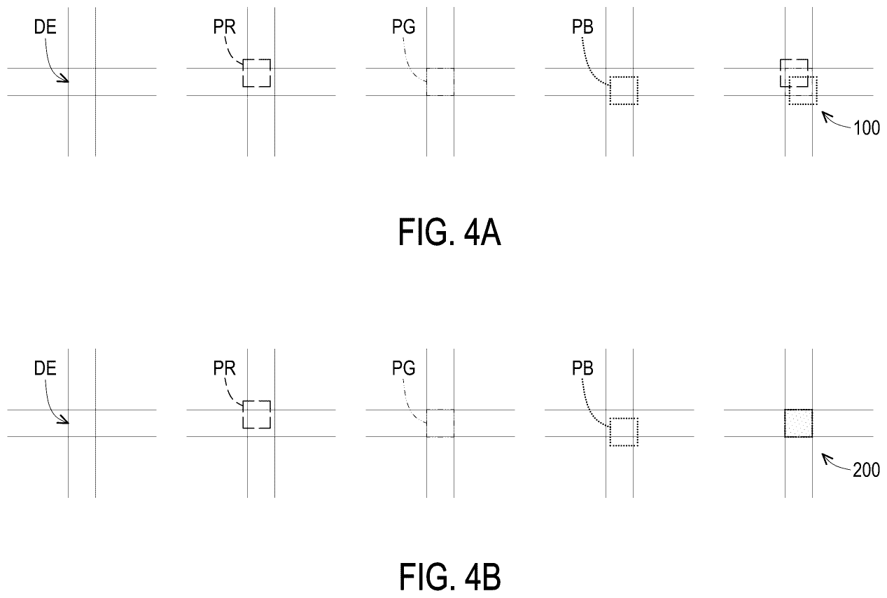

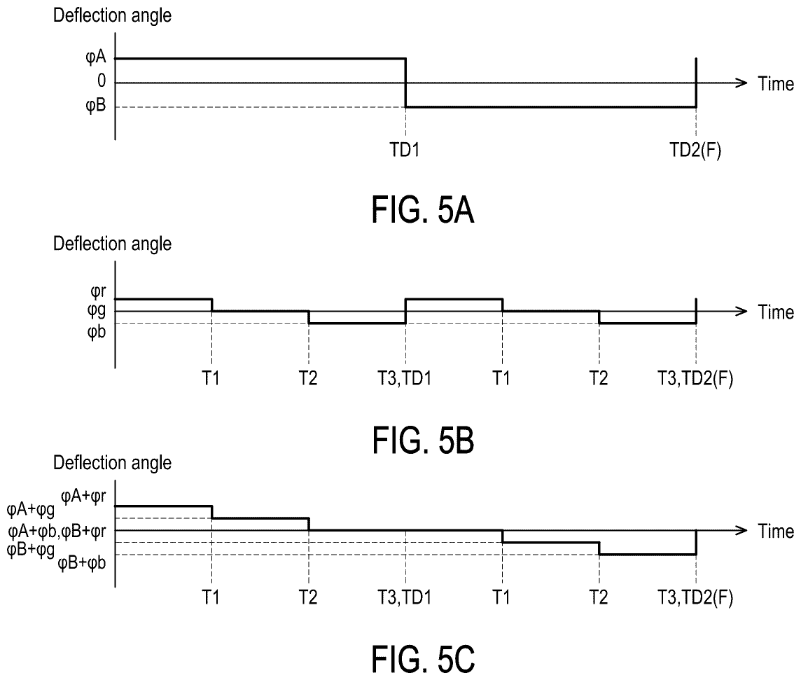

FIG. 5A is a diagram showing a relationship between deflection angles in each period when the actuator performs a pixel shift operation according to an embodiment of the disclosure. FIG. 5B is a diagram showing a relationship between the deflection angles in each period when the actuator performs a lateral color compensation operation according to an embodiment of the disclosure. FIG. 5C is a diagram showing a relationship between the deflection angles in each period when the actuator performs a pixel shift operation and a lateral color compensation operation at the same time according to an embodiment of the disclosure. In the embodiment, the light source module 10 may provide the first color light R, the second color light G and the third color light B at different periods in a same frame image IP, thereby providing a color image. Namely, in the embodiment, the light source module 10 may include a color wheel to separate colors of the light beam, and use a time multiplex color wheel method to generate a color image light beam. Referring to FIG. 1 and FIG. 5B at the same time, for example, a period of each frame F of the image IP provided by the projection device 1A includes a first period (such as time 0 to time T1 or time T3 to time T1 to the right of a time axis), a second period (such as time T1 to time T2 to the right of the time axis) and a third period (such as time T2 to time T3 to the right of the time axis), the light source module 10 provides the first color light R in the first period, the second color light G in the second period, and the third color light B in the third period. On the other hand, a light modulation element of the light modulation module 20 respectively converts the first color light R into the first image light IR in the first period, converts the second color light G into the second image light IG in the second period, and converts the third color light B into the third image light IB in the third period. On the other hand, at least one actuator 30A of the actuation module 30 receives the first image light IR in the first period, the second image light IG in the second period, and the third image light IB in the third period. When the actuation module 30 performs the lateral color compensation operation, the light incident surface IF of the actuator 30A does not deflect relative to the reference surface SS during the second period, and the deflection angle ϕg at this time is, for example, 0. In the first period, the light incident surface IF of the actuator 30A has a first deflection angle ϕr relative to the light incident surface IF in the second period; in the third period, the light incident surface IF of the actuator 30A has a second deflection angle ϕb relative to the light incident surface IF in the second period. In an embodiment, the first deflection angle ϕr and the second deflection angle ϕb have a same magnitude (value) but different directions, and the disclosure is not limited thereto. In addition, for relevant content of the embodiment, reference may be made to the aforementioned description of FIG. 2A to FIG. 2E, and detail thereof is not repeated.

Referring again to FIG. 5A, when the actuation module 30 performs a pixel shift operation, each period of the frame F of the image IP includes at least two pixel displacement periods. For example, one frame F may be divided into a first pixel displacement period (i.e., time 0 to time TD1 to the right of the time axis) and a second pixel displacement period (i.e., time TD1 to time TD2 to the right of the time axis). In the first pixel displacement period, the light incident surface IF of the actuator 30A has a third deflection angle ϕA corresponding to the generated pixel displacement (for example, a distance of a half of the first pixel PR) relative to the reference surface SS; while in the second pixel During the displacement period, the light incident surface IF of the actuator 30A has a third deflection angle ϕB corresponding to the generated pixel displacement relative to the reference surface SS, where the third deflection angle A and the third deflection angle ϕB may be angles with the same magnitude but opposite deflection directions, but the disclosure is not limited thereto. In this way, the first image light IR, the second image light IG and the third image light IB may be shifted back and forth within one frame F, which increases a viewing resolution of the image IP by 2 times (for example, 2K to 4K) without the user's awareness. In some embodiments, one frame F may also be divided into four pixel displacement periods to increase the resolution of the image IP by 4 times (for example, 2K to 8K), but the disclosure is not limited thereto.

Referring to FIG. 5C, furthermore, the actuation module 30 may simultaneously consider the first deflection angle ϕr, the deflection angle ϕg, the second deflection angle ϕb and the third deflection angles ϕA and ϕB to control the actuation module 30 to deflect to a required angle, so as to simultaneously achieve the functions of improving resolution and lateral color compensation. For example, each of the first pixel shift period and the second pixel shift period may include a first period, a second period, and a third period, and the actuation module 30 may also perform the above-mentioned pixel shift operation and lateral color compensation operation simultaneously. For example, during the first period from time 0 to T1, the light incident surface IF of the actuator 30A has a fourth deflection angle relative to the reference surface SS, and the fourth deflection angle is a sum of the first deflection angle ϕr and the third deflection angle ϕA, or in another first period from time TD1 to time T1 to the right of the time axis, the light incident surface IF of the actuator 30A has the fourth deflection angle relative to the reference surface SS, and the fourth deflection angle is a sum of the first deflection angle ϕr and the third deflection angle ϕB. In FIG. 5C, the first deflection angle ϕr and the third deflection angle ϕB are equal in magnitude but opposite in direction, so that coordinate (ϕr+ϕB) is 0, i.e., they are overlapped with the time axis for representation, but the disclosure is not limited thereto.

Similarly, during the second period from time T1 to time T2 to the right side of the time axis, the light incident surface IF of the actuator 30A has a third deflection angle ϕA or ϕB relative to the reference surface SS. The reason is that in the embodiment, a position of the second color pixel PG formed by the second image light IG is used as the preset range DE (as shown in FIG. 4B), and for the lateral color compensation operation, the actuator 30A without deflection in the second period is used as an example, so that the deflection angle ϕg is substantially 0 degree. In the second period, when the actuator 30A needs to perform the pixel shift operation and the lateral color compensation operation at the same time, the actuator 30A only needs to deflect the third deflection angle ϕA or ϕB (i.e., ϕA+ϕg=ϕA, or ϕB+ϕg=ϕB in FIG. 5C), the above may be referred for the relevant description, and detail thereof is not repeated.

Similarly, during the third period from time T2 to T3 to the right of the time axis, the light incident surface IF of the actuator 30A has a fifth deflection angle relative to the reference surface SS, and the fifth deflection angle is a sum of the second deflection angle ϕb and the third deflection angle A. Here, the situation that the second deflection angle ϕb and the third deflection angle A have the same magnitude but opposite directions is taken as an example for description, so that the coordinate (ϕb+ϕA) is 0. However, the disclosure is not limited thereto. In addition, in another third period from another time T2 to the time TD2 to the right of the time axis, the fifth deflection angle is a sum of the second deflection angle ϕb and the third deflection angle ϕB. Here, the situation that the second deflection angle ϕb and the third deflection angle ϕB have the same direction is taken as an example for description, but the disclosure is not limited thereto. Accordingly, as shown in FIG. 5C, under the operation of the actuator 30A with corresponding deflection angles in different periods, the first image light IR, the second image light IG and the third image light IB may be transmitted to the projection lens 40 through the actuation module 30, so as to be projected into the preset range DE of the image IP, so that the lateral color of the image IP may be improved, and the resolution may also be improved.

Other embodiments will be provided below to describe the disclosure in detail, where the same reference numbers denote the same or like components, and descriptions of the same technical contents are omitted. The aforementioned embodiment may be referred for descriptions of the omitted parts, and detailed descriptions thereof are not repeated in the following embodiment.

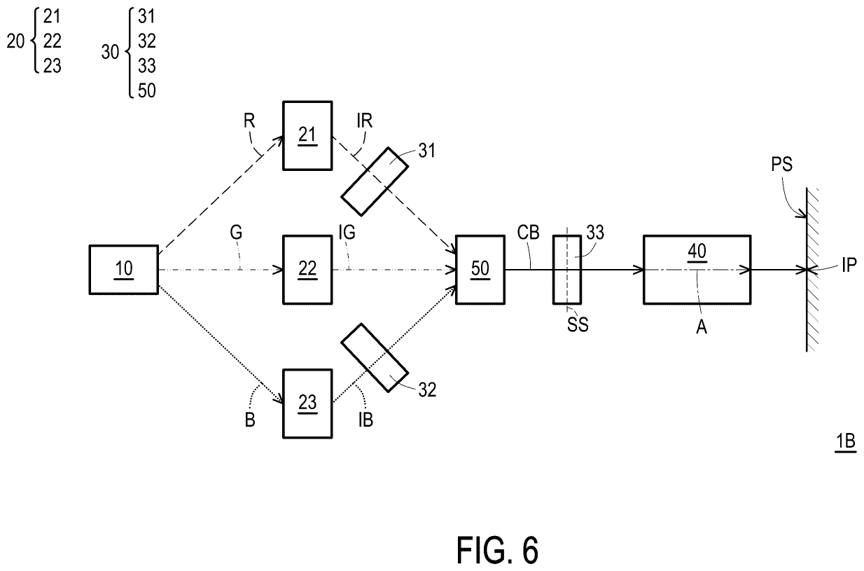

In an embodiment, the light source module 10 may use multiple sets of light sources to simultaneously provide the first color light R, the second color light G, and the third color light B, i.e., the light source module 10 provides the above three color lights in a same timing sequence. FIG. 6 is a schematic structural diagram of a projection device according to an embodiment of the disclosure. Referring to FIG. 6, a projection device 1B of the embodiment is similar to the projection device 1A in FIG. 1, and the differences are as follows. In the projection device 1B, the light modulation module 20 further includes a first light modulation element 21, a second light modulation element 22 and a third light modulation element 23. The first light modulation element 21 is disposed on a transmission path of the first color light R for converting the first color light R into the first image light IR. The second light modulation element 22 is disposed on a transmission path of the second color light G for converting the second color light G into the second image light IG, and the third light modulation element 23 is disposed on a transmission path of the third color light B for converting the third color light B into the third image light IB. On the other hand, at least one actuator in the actuation module 30 includes a first actuator 31 and a second actuator 32. The first actuator 31 is disposed on a transmission path of the first image light IR for receiving the first image light IR. The second actuator 32 is disposed on a transmission path of the third image light IB for receiving the third image light IB. The actuation module 30 of the projection device 1B further includes a prism group 50, which is disposed on the transmission path of the first image light IR, the second image light IG and the third image light IB, and is used for receiving the second image light IG and the first image light IR passing through the first actuator 31 and the third image light IB passing through the second actuator 32, and combining the first image light IR, the second image light IG and the third image light IB into a combined light beam CB. The combined light beam CB includes at least two of the first image light IR, the second image light IG and the third image light IB. The actuation module 30 of the projection device 1B further includes a third actuator 33 disposed between the prism group 50 and the projection lens 40. The third actuator 33 is used to receive the combined light beam CB and perform a pixel shift operation to transmit the combined light beam CB to the projection lens 40 to generate the image IP. In other words, the projection device 1B may be a 3DLP projector system in the embodiment.

The first light modulation element 21, the second light modulation element 22 and the third light modulation element 23 may be the aforementioned DMD, and the first actuator 31 and the second actuator 32 may have the same structure and function as that of the aforementioned actuator 30A, which are not repeated. The prism group 50 may include a plurality of lenses with refractive power. In the schematic structural diagram of FIG. 6, although the first color light R and the third color light B are shown as obliquely incident on the first light modulation element 21 and the third light modulation element 23 respectively, in an actual optical path structure, the first color light R and the third color light B may be substantially vertically incident on the light incident surfaces of the first light modulation element 21 and the third light modulation element 23 respectively. Similarly, in the actual optical path structure, the first image light IR and the third image light IB may also be substantially vertically incident on the light incident surface IF of the first actuator 31 and the second actuator 32 respectively. Furthermore, when the first image light IR, the second image light IG and the third image light IB are transmitted to the prism group 50 in the actual optical path structure, they may also be incident to the prism group 50 in a manner of parallel to an optical axis (not shown) of the prism group 50.

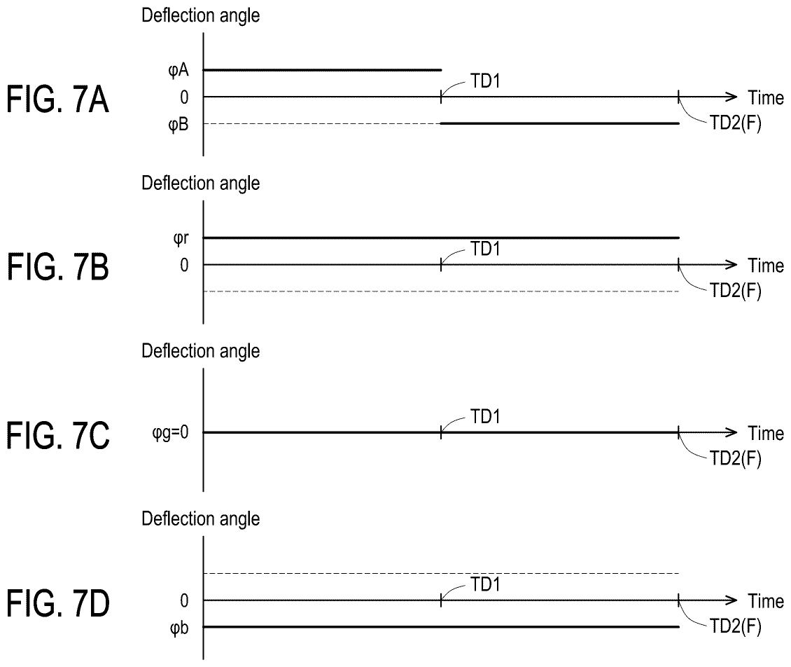

In the embodiment, the projection device 1B uses the first actuator 31 and the second actuator 32 to perform a lateral color compensation operation, and uses the third actuator 33 to perform a pixel shift operation. FIG. 7A to FIG. 7D are diagrams illustrating a relationship between deflection angles in each period when the actuation module of the projection device of the embodiment of FIG. 6 performs operations (i.e., the pixel shift operation and the lateral color compensation operation). As shown in FIG. 7A, during the first pixel displacement period (i.e., time 0 to time TD1 to the right of the time axis) and the second pixel displacement period (i.e., time TD1 to time TD2 to the right of the time axis) within the period of the same frame F, the third actuator 33 performs a pixel shift operation on the combined light beam CB, and the light incident surface IF has the third deflection angles ϕA and ϕB corresponding to the generated pixel displacement relative to the reference surface SS.

In FIG. 7C, during the period of the same frame F, since the second image light IG is not provided with an actuator in the path between the second light modulation element 22 and the prism group 50, the deflection angle ϕg is regarded as 0 degree. In FIG. 7B, the first actuator 31 performs the lateral color compensation operation on the first image light IR, so the light incident surface IF is adapted to be deflected relative to the reference surface SS to have the first deflection angle ϕr. Similarly, in FIG. 7D, the second actuator 32 performs the lateral color compensation operation on the third image light IB, so that the light incident surface IF is adapted to be deflected relative to the reference surface SS to have a second deflection angle ϕb, the first deflection angle or and the second deflection angle ϕb have different directions, and the first deflection angle ϕr and the second deflection angle ϕb may have the same or different magnitudes, but the disclosure is not limited thereto. In the embodiment, the angle shift of each actuator is simplified through the above structure, and the difficulty of circuit design, programming and angle control may be further reduced.

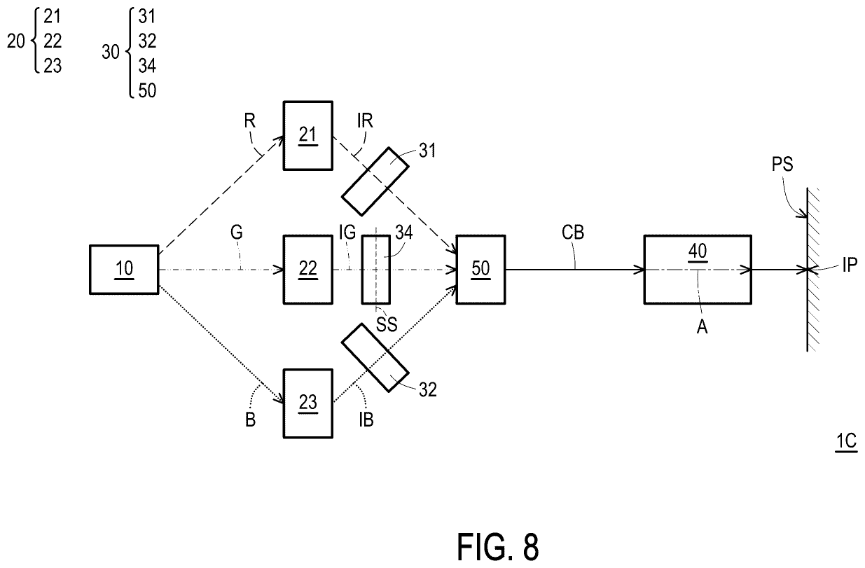

FIG. 8 is a schematic structural diagram of a projection device according to an embodiment of the disclosure. A projection device 1C of the embodiment is similar to the projection device 1B in FIG. 6, and the differences are as follows. In the projection device 1C, the third actuator 33 is not provided between the prism group 50 and the projection lens 40. In addition, the actuation module 30 of the projection device 1C further includes a fourth actuator 34 disposed on the transmission path of the second image light IG for receiving the second image light IG. Specifically, the fourth actuator 34 is disposed between the second light modulation element 22 and the prism group 50, and the prism group 50 receives the first image light IR passing through the first actuator 31, the second image light IG passing through the fourth actuator 34 and the third image light IB passing through the second actuator 32, and combines the same into the combined light beam CB.

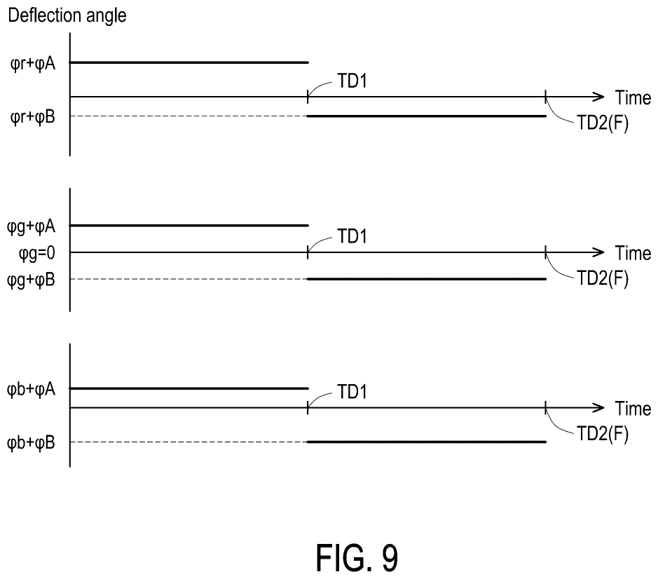

In the embodiment, the projection device 1C uses the first actuator 31 and the second actuator 32 to simultaneously perform the pixel shift operation and the lateral color compensation operation, and uses the fourth actuator 34 to perform the pixel shift operation. FIG. 9 is a diagram showing a relationship between deflection angles in each period when the actuation module of the projection device of the embodiment of FIG. 8 performs operations (the actuation modules 31, 34, 32 are represented from up to down). Referring to FIG. 8 to FIG. 9 at the same time, similar to the aforementioned FIG. 5A to FIG. 5C, when the actuation module 30 performs the pixel shift operation and the lateral color compensation operation at the same time, the light incident surface IF of each of the first actuator 31, the second actuator 32 and the fourth actuator 34 may have a corresponding deflection angle respectively to achieve the functions of improving resolution and lateral color compensation. For example, a period of the same frame F includes at least two pixel displacement periods. For example, in FIG. 9, a time before the time TD1 may be defined as the first pixel displacement period, and the time TD1 to the time TD2 may be defined as the second pixel displacement period. During the first pixel displacement period, the light incident surface IF of the first actuator 31 has a fourth deflection angle relative to the reference surface SS, and the fourth deflection angle may be a sum of the first deflection angle ϕr and the third deflection angle ϕA. During the second pixel displacement period, the fourth deflection angle of the first actuator 31 may be a sum of the first deflection angle ϕr and the third deflection angle ϕB.

Similarly, since the second color pixel PG formed by the second image light IG may be regarded as the preset range DE, the fourth actuator 34 correspondingly receiving the second image light IG does not need to perform the lateral color compensation operation, and the deflection angle ϕg of the fourth actuator 34 may be regarded as 0. Therefore, the fourth actuator 34 may only need to perform the pixel shift operation. For example, during the first pixel displacement period, the light incident surface IF of the fourth actuator 34 may have the third deflection angle ϕA relative to the reference surface SS, and during the second pixel displacement period, the light incident surface IF of the fourth actuator 34 may be the third deflection angle ϕB relative to the reference surface SS.

Further, during the first pixel displacement period, the light incident surface IF of the second actuator 32 has a fifth deflection angle relative to the reference surface SS, and the fifth deflection angle may be a sum of the second deflection angle ϕb and the third deflection angle ϕA. During the second pixel displacement period, the fifth deflection angle of the second actuator 32 may be a sum of the second deflection angle ϕb and the third deflection angle ϕB.

Accordingly, in addition to achieving the effects of the various projection devices in the aforementioned embodiments, the projection device 1C may use multiple actuators to provide lateral color compensation for different colors of light, and angle placement of the multiple actuators is simple, making the circuit design and programming design easy and electrical signal control simple. The placement of each deflection angle may also be more accurate, and the effect of mitigating lateral color by the projection device 1C may be easily achieved.

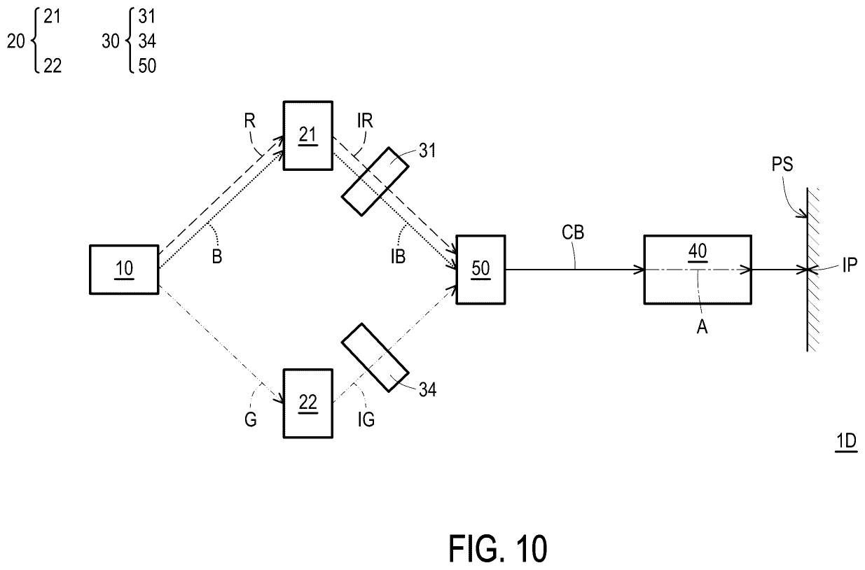

FIG. 10 is a schematic structural diagram of a projection device according to an embodiment of the disclosure. Referring to FIG. 10, a projection device 1D of the embodiment is similar to the projection device 1A in FIG. 1, and the differences are as follows. In the projection device 1D, the light modulation module 20 further includes a first light modulation element 21 and a second light modulation element 22. The first light modulation element 21 is disposed on the transmission path of the first color light R and the third color light B, and is configured to convert the first color light R into the first image light IR, and convert the third color light B into the third image light IB. Similarly, the second light modulation element 22 is disposed on the transmission path of the second color light G for converting the second color light G into the second image light IG. On the other hand, the actuation module 30 includes a first actuator 31 and a fourth actuator 34. The first actuator 31 is disposed on the transmission path of the first image light IR and the third image light IB for receiving the first image light IR and the third image light IB. The fourth actuator 34 is disposed on the transmission path of the second image light IG for receiving the second image light IG. The projection device 1D further includes a prism group 50, which is disposed on the transmission path of the first image light IR, the second image light IG and the third image light IB, and is configured to receive the second image light IG passing through the fourth actuator 34 and the first image light IR and the third image light IB passing through the first actuator 31. In other words, the projection device 1D may be a 2DLP projector system in the embodiment.

In the embodiment, the situation that the light source module 10 provides the first color light R, the second color light G and the third color light B in different timings is taken as an example for description. However, in other embodiments, the timing sequence for the light source module 10 providing the first color light R, the second color light G and the third color light B are at least partly the same, but the disclosure is not limited thereto. Therefore, in the structure of the 2DLP projector system, the prism group 50 is configured to combine the first image light IR, the second image light IG, and the third image light IB into the combined light beam CB, and transmit the combined light beam CB to the projection lens 40. The combined light beam CB includes at least one of the first image light IR, the second image light IG, and the third image light IB.

Similar to the operation principle of the actuator 30A of FIG. 2A to FIG. 2E, and the relationship between deflection angles in each period when the actuator of FIG. 5A to FIG. 5C performs the pixel shift operation and the lateral color compensation operation, when the first actuator 31 performs the lateral color compensation operation, in the timing of the first color light R of the same frame F (for example, the first period of time 0 to time T1 of FIG. 5B, or another first period from time TD1 to time T1 to the right of the time axis), the light incident surface IF of the first actuator 31 is adapted to be deflected relative to the reference surface SS to have the first deflection angle ϕr, and at this time, the lateral color of the first image light IR may be compensated. In the timing of the third color light B (for example, the third period from time T2 to time T3 in FIG. 5B, or another third period from another time T2 to time TD2 to the right of the time axis), the light incident surface IF of the first actuator 31 is adapted to be deflected relative to the reference surface SS to have the second deflection angle ϕb, where the first deflection angle or and the second deflection angle ϕb have different directions. At this time, the lateral color of the third image light IB may be compensated. The description of FIG. 5B may be referred for the relevant paragraphs and principles, and details thereof are not repeated.

Referring to FIG. 5A, in the embodiment, when the actuation module 30 performs a pixel shift operation, the light incident surface IF of the first actuator 31 and the light incident surface IF of the fourth actuator 34 have the third deflection angle DA or ϕB corresponding pixel displacements relative to the reference surface SS. Similarly, referring to FIG. 5C, when the actuation module 30 performs the pixel shift operation and the lateral color compensation operation at the same time, in the timing of the first color light R, the light incident surface IF of the first actuator 31 has a fourth deflection angle relative to the reference surface SS, and the fourth deflection angle is, for example, a sum of the first deflection angle ϕr and the third deflection angle (i.e., ϕA+ϕr or ϕB+ϕr) in the previous paragraph or in FIG. 5C. In the timing of the second color light G, the second color pixel PG formed by the second image light IG may be regarded as the preset range DE, the fourth actuator 34 does not need to perform the lateral color compensation operation, and the deflection angle ϕg may be regarded as 0, so that the light incident surface IF of the fourth actuator 34 has the third deflection angle ϕA or ϕB (represented by ϕA+ϕg or ϕB+ϕg in FIG. 5C) relative to the reference surface SS. Similarly, in the timing of the third color light B, the light incident surface IF of the first actuator 31 has a fifth deflection angle relative to the reference surface SS. The fifth deflection angle is, for example, a sum of the second deflection angle ϕb and the third deflection angle (i.e. ϕA+ϕb or ϕB+ϕb) as mentioned above or in FIG. 5C. The descriptions of FIG. 5A to FIG. 5C may be referred for the relevant paragraphs and principles, and details thereof are not repeated.

In summary, the projection device of the disclosure uses an actuation module to refract light beams of different colors, which may cause different shifts to different color pixels in each pixel. Therefore, even if different colors of light are shifted due to different refraction angles in the projection device, the shift amount caused by the actuation module may compensate for the shift of different colors of light, so that the image beams of different colors may be substantially overlapped within the preset range, i.e., image beams of different colors are formed at expected positions of each pixel in the image frame. Therefore, the problem of chromatic dispersion or lateral color of image may be mitigated, which effectively improves the imaging quality of the image and increase the user's viewing experience. On the other hand, compared to redesigning or remolding a projection lens with a complex structure to solve such issues, the deflection method of the actuation module used in the disclosure is relatively simple, and the original projection lens structure may also be used to increase flexibility in component selection for the projection device.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projection device, comprising a light source module, a light modulation module, an actuation module and a projection lens, wherein:
the light source module is configured to provide first color light and second color light, wherein a wavelength distribution of the first color light is different from a wavelength distribution of the second color light;
the light modulation module is disposed on a transmission path of the first color light and the second color light, and is configured to convert the first color light and the second color light into first image light and second image light respectively;
the actuation module is disposed on a transmission path of the first image light and the second image light, and located between the light modulation module and the projection lens, and is configured to receive the first image light and the second image light, the actuation module comprises at least one actuator, and each of the at least one actuator has a light incident surface adapted to be deflected relative to a reference surface; and
the projection lens is disposed on the transmission path of the first image light and the second image light, and is configured to receive the first image light and the second image light, wherein when the actuation module performs a lateral color compensation operation, the light incident surface of the at least one actuator when receiving the first image light has a first deflection angle relative to the light incident surface of the at least one actuator when receiving the second image light, and the first image light and the second image light are projected to a preset range through the projection lens to generate an image.

2. The projection device as claimed in claim 1, wherein the light source module is further configured to provide a third color light, a wavelength distribution of the third color light is different from the wavelength distribution of the first color light and the wavelength distribution of the second color light, the light modulation module is disposed on a transmission path of the third color light, and is configured to convert the third color light into a third image light, the actuation module and the projection lens are disposed on the transmission path of the third image light to receive the third image light, when the actuation module performs the lateral color compensation operation, the light incident surface of the at least one actuator when receiving the third image light has a second deflection angle relative to the light incident surface of the at least one actuator when receiving the second image light, and directions of the first direction angle and the second deflection angle are different.

3. The projection device as claimed in claim 1, wherein when the actuation module performs the lateral color compensation operation, the light incident surface of the at least one actuator when receiving the second image light is not deflected relative to the reference surface.

4. The projection device as claimed in claim 1, wherein each frame of the image comprises a first period and a second period, the light source module provides the first color light during the first period, and provides the second color light during the second period, the at least one actuator of the actuation module receives the first image light during the first period, and the at least one actuator of the actuation module receives the second image light during the second period.

5. The projection device as claimed in claim 4, wherein a same frame of the image further comprises a third period, and the light source module is further configured to provide a third color light in the third period, a wavelength distribution of the third color light is different from the wavelength distribution of the first color light and the wavelength distribution of the second color light,
wherein the light modulation module is further configured to convert the third color light into a third image light,
the at least one actuator is configured to receive the third image light during the third period,
wherein when the actuation module performs the lateral color compensation operation, the light incident surface of the at least one actuator when receiving the third image light has a second deflection angle relative to the light incident surface of the at least one actuator when receiving the second image light.

6. The projection device as claimed in claim 5, wherein the first deflection angle and the second deflection angle have a same magnitude but different directions.

7. The projection device as claimed in claim 5, wherein the light modulation module comprises a light modulation element, the light modulation element converts the first color light into the first image light during the first period, the light modulation element converts the second color light into the second image light during the second period, and the light modulation element converts the third color light into the third image light during the third period.

8. The projection device as claimed in claim 5, wherein each frame of the image comprises at least two pixel displacement periods, each of the at least two pixel displacement periods comprises the first period, the second period and the third period,
wherein when the actuation module performs a pixel shift operation, in each of the at least two pixel displacement periods, the light incident surface of the at least one actuator has a third deflection angle corresponding to pixel displacement relative to the reference surface,
when the actuation module performs the pixel shift operation and the lateral color compensation operation at the same time,
during the first period, the light incident surface of the at least one actuator has a fourth deflection angle relative to the reference surface, and the fourth deflection angle is a sum of the first deflection angle and the third deflection angle,
during the second period, the light incident surface of the at least one actuator has the third deflection angle relative to the reference surface,
during the third period, the light incident surface of the at least one actuator has a fifth deflection angle relative to the reference surface, and the fifth deflection angle is a sum of the second deflection angle and the third deflection angle, so that the first image light, the second image light and the third image light are projected into the preset range through the projection lens.

9. The projection device as claimed in claim 1, wherein the light source module is further configured to provide a third color light, a wavelength distribution of the third color light is different from the wavelength distribution of the first color light and the wavelength distribution of the second color light, and timing sequences for the light source module providing the first color light, the second color light and the third color light are all the same,
wherein the light modulation module is further configured to convert the third color light into a third image light,
wherein the at least one actuator comprises a first actuator and a second actuator, the first actuator is disposed on the transmission path of the first image light to receive the first image light, the second actuator is disposed on a transmission path of the third image light to receive the third image light, when the actuation module performs the lateral color compensation operation, the light incident surface of the first actuator is adapted to be deflected relative to the reference surface to have the first deflection angle, the light incident surface of the second actuator is adapted to be deflected relative to the reference surface to have a second deflection angle, and the first deflection angle and the second deflection angle have different directions.

10. The projection device as claimed in claim 9, wherein the light modulation module comprises a first light modulation element, a second light modulation element and a third light modulation element, the first light modulation element is disposed on the transmission path of the first color light for converting the first color light into the first image light, the second light modulation element is disposed on the transmission path of the second color light for converting the second color light into the second image light, and the third light modulation element is disposed on the transmission path of the third color light for converting the third color light into the third image light.

11. The projection device as claimed in claim 9, wherein the actuation module further comprises a prism group and a third actuator, wherein
the prism group is disposed on the transmission path of the first image light, the second image light and the third image light, and is configured to receive the second image light, the first image light passing through the first actuator and the third image light passing through the second actuator, and combine the first image light, the second image light and the third image light into a combined light beam, the combined light beam comprises at least two of the first image light, the second image light and the third image light; and
the third actuator is disposed between the prism group and the projection lens, and the third actuator is configured to receive the combined light beam and perform a pixel shift operation to transmit the combined light beam to the projection lens to generate the image.

12. The projection device as claimed in claim 9, wherein the actuation module further comprises a fourth actuator and prism group, wherein
the fourth actuator is disposed on the transmission path of the second image light to receive the second image light; and
the prism group is disposed on the transmission path of the first image light, the second image light and the third image light, and is configured to receive the first image light passing through the first actuator, the second image light passing through the fourth actuator and the third image light passing through the second actuator, and combine the first image light, the second image light and the third image light into a combined light beam, and transmit the combined light beam to the projection lens to generate the image.

13. The projection device as claimed in claim 12, wherein each frame of the image comprises at least two pixel displacement periods, when the actuation module performs a pixel shift operation, in each of the at least two pixel displacement periods, the light incident surface of the first actuator, the light incident surface of the second actuator and the light incident surface of the fourth actuator have a third deflection angle corresponding to pixel displacement relative to the reference surface,
when the actuation module performs the pixel shift operation and the lateral color compensation operation at the same time,
the light incident surface of the first actuator has a fourth deflection angle relative to the reference surface, and the fourth deflection angle is a sum of the first deflection angle and the third deflection angle,
the light incident surface of the fourth actuator has the third deflection angle relative to the reference surface, and
the light incident surface of the second actuator has a fifth deflection angle relative to the reference surface, and the fifth deflection angle is a sum of the second deflection angle and the third deflection angle.

14. The projection device as claimed in claim 1, wherein the light source module is further configured to provide a third color light, a wavelength distribution of the third color light is different from the wavelength distribution of the first color light and the wavelength distribution of the second color light, and timing sequences for the light source module providing the first color light, the second color light and the third color light are all different,
wherein the light modulation module comprises a first light modulation element and a second light modulation element, the first light modulation element is disposed on the transmission path of the first color light and the third color light, and is configured to convert the first color light into the first image light and convert the third color light into the third image light, and the second light modulation element is disposed on the transmission path of the second color light, and is configured to convert the second color light into the second image light.

15. The projection device as claimed in claim 14, wherein the at least one actuator comprises a first actuator and a fourth actuator, the first actuator is disposed on the transmission path of the first image light and the third image light to receive the first image light and the third image light, the fourth actuator is disposed on the transmission path of the second image light to receive the second image light, when the first actuator performs the lateral color compensation operation, in a timing of the first color light, the light incident surface of the first actuator is adapted to be deflected relative to the reference surface to have the first deflection angle, in a timing of the third color light, the light incident surface of the first actuator is adapted to be deflected relative to the reference surface to have a second deflection angle, where directions of the first deflection angle and the second deflection angle are different.

16. The projection device as claimed in claim 15, wherein when the actuation module performs a pixel shift operation, the light incident surface of the first actuator and the light incident surface of the fourth actuator have a third deflection angle corresponding to pixel displacement relative to the reference surface,
when the actuation module performs the pixel shift operation and the lateral color compensation operation at the same time,
in a timing of the first color light, the light incident surface of the first actuator has a fourth deflection angle relative to the reference surface, and the fourth deflection angle is a sum of the first deflection angle and the third deflection angle,
in a timing of the second color light, the light incident surface of the fourth actuator has the third deflection angle relative to the reference surface, and
in a timing of the third color light, the light incident surface of the first actuator has a fifth deflection angle relative to the reference surface, and the fifth deflection angle is a sum of the second deflection angle and the third deflection angle.

17. The projection device as claimed in claim 1, wherein a number of the at least one actuator is two, and the two actuators are respectively one-dimensional deflection actuators.

18. The projection device as claimed in claim 1, wherein the at least one actuator is a two-dimensional deflection actuator.

19. The projection device as claimed in claim 1, wherein in each frame of the image, the first image light and the second image light completely overlap on at least one pixel of the image.

20. The projection device as claimed in claim 1, wherein the reference surface is parallel to a plane perpendicular to an optical axis of the projection lens.
